(19) United States
(12) Patent Application Publication
(10) Pub. No.: US 2022/0243696 A1
(43) Pub. Date: Aug. 4, 2022

(54) POWER GENERATION SYSTEM

(71) Applicant: Oded MANSOR, Petah-Tikva (IL)

(72) Inventor: Oded MANSOR, Petah-Tikva (IL)

(21) Appl. No.: 17/572,893

(22) Filed: Jan. 11, 2022

(30) Foreign Application Priority Data
Feb. 3, 2021 (IL) 280615

(51) Int. Cl. F03B 13/10; F03B 17/02

(52) U.S. Cl. CPC F03B 13/10; F03B 17/025

(57) ABSTRACT

A power generation system including a telescopic tubular apparatus with a flotation device, the flotation device configured to be displaced inside the tubular apparatus and to extend outwardly from the tubular apparatus, a base apparatus configured to support the tubular apparatus, and a hinge mechanism configured to allow the tubular apparatus to pivot upwards and downward on the base apparatus, wherein at a predetermined pivot angle, the length of the downward side of the tubular apparatus is lengthened and that of the opposing upper side is shortened.

### CROSS REFERENCE TO RELATED APPLICATIONS

This application claims the benefit of priority of Israel Patent Application No. IL 280615 filed on Feb. 3, 2021, the contents of which are all incorporated herein by reference in their entirety

### FIELD OF THE INVENTION

The present invention, in some embodiments thereof, relates to power generation systems and, more particularly, but not exclusively, to energy-exchange-based power generation system.

### BACKGROUND OF THE INVENTION

Many existing power generation systems rely on the use of energy sources such as electricity, gas, steam, fuels, and solar energy, among other types of energy sources. Most of these power generation systems are expensive to operate, with some contributing to polluting the environment. Additionally, some of the energy sources are non-renewable, which may cause environmental unbalances and may affect humans as well as animal life and plant life.

Some power plants use gravitational potential energy to generate power. Examples of these plants include hydroelectric power plants which convert the potential energy in water stored in a reservoir into kinetic energy as the water falls through a penstock, driving a turbine which produces electricity. Other examples include tidal power plants, more specifically, tidal barrage plants, which include a dam-like structure (tidal barrage) used to capture the energy from masses of water moving in and out of a bay or river due to tidal forces. The stored potential energy in the stored water is converted into kinetic energy as the water flows in and out of the river or bay during changes in tide, driving a turbine which produces electricity. Despite the use of stored potential energy, hydroelectric power stations and tidal barrage plants may have severe environmental impact and may pose significant environmental hazards to animal life and plant life.

### SUMMARY OF THE INVENTION

There is provided, in accordance with an embodiment of the present discloser a power generation system comprising: a telescopic tubular apparatus comprises: a hollow cylindrical tube which is pivotally attached to a hinge mechanism on top of a support on a base apparatus; and a flotation device configured to move inside an interior of the hollow cylindric tube from a first side of the hollow cylindric tube to the second side of the hollow cylindric based on the flotation power of water and a weight of the flotation device and extend outwardly from the tubular apparatus when the tubular apparatus is moving upwards and downwards around the hinge mechanism, wherein when the hinge mechanism is locked at a predetermined pivot angle, a length of a downward-tilted side of the tubular apparatus is longer than a length of the upwards-tilted side.

In some demonstrative embodiments, the power generation system comprises a driver pulley wheel operably attached to the hinge mechanism; a drive belt connected at one end to the driver pulley wheel and at the other end to a driven pulley wheel, and an electric motor connected to the driven pulley wheel, wherein the electric motor is configured to be used as a starter of the telescopic tubular apparatus movement.

In some demonstrative embodiments, the hollow cylindrical tube comprises a first cap at a first end of the cylindrical tube, wherein the first cap is configured to seal the first end of the cylindrical tube and a second cap at a second end cylindrical tube configured to seal the second end of the cylindrical tube.

In some demonstrative embodiments, when the floatation device is extended from the first end the first cap is attached to the flotation device by a first magnet and when the floatation device is extended from the first end the first cap is attached to the flotation device by a second magnet.

In some demonstrative embodiments, the hollow cylindrical tube comprises a first sealing ring at one the first end and a second sealing ring at the second end of the cylindrical tool.

In some demonstrative embodiments, the system of comprises a computer configured to: control a computerized locking system to lock said hinge mechanism at a predetermined angle when the flotation device is downward at a first side of said hinge mechanism; unlock said hinge mechanism for a predetermined amount of time when the flotation device is upwards at the first side of said hinge mechanism to enable the flotation device to move inside an interior of the hollow cylindric tube and to pull down a second side of the said hinge mechanism.

In some demonstrative embodiments, said predetermined angle comprises an angle formed by a longitudinal axis of the tubular assembly relative to a vertical axis of the base apparatus.

In some demonstrative embodiments, said predetermined angle is 70° degrees.

In some demonstrative embodiments, the system comprises a sensor to detect a position of said flotation device in said tubular assembly and to lock the flotation device at the detected position, wherein the lock is done by a stopper mechanism.

In some demonstrative embodiments, said the mechanism comprises an electromagnetic device.

In some demonstrative embodiments, the power generation system comprises a suction mechanism configure to suck the air from the telescopic tubular apparatus.

In some demonstrative embodiments, the power generation system comprises a suction mechanism configure to suck a liquid from the telescopic tubular apparatus.

In some demonstrative embodiments, the power generation system comprises a first pipe operably coupled to the first cap and configured to release an air from the telescopic tubular apparatus when the floating device is moving to one direction of the tubular apparatus; and a second pipe operably coupled to the second cup and configured to release an air from the telescopic tubular apparatus when the floating device is moving to opposite direction of the tubular apparatus.

In some demonstrative embodiments, the power generation system comprises a first pipe operably coupled to a first end of the tubular apparatus and configured to release an air from the telescopic tubular apparatus when the floating device is moving to one direction of the tubular apparatus; and a second pipe operably coupled to a second end of the tubular apparatus and configured to release an air from the telescopic tubular apparatus when the floating device is moving to opposite direction of the tubular apparatus.

In some embodiments, the base apparatus includes a pedestal. Additionally, the base apparatus includes vertical support. Additionally, the base apparatus is submerged in water.

In some embodiments, the system includes a drive pulley wheel. Additionally, the system includes a drive belt. Optionally, the system includes a generator, additionally or alternatively, the system includes a motor. Optionally, the system includes an ozonator.

### BRIEF DESCRIPTION OF THE DRAWINGS

Some embodiments of the invention are herein described, by way of example only, with reference to the accompanying drawings. Details shown are for exemplary purposes and serve to provide a discussion of embodiments of the invention. The description and the drawings may be apparent to those skilled in the art how embodiments of the invention may be practiced.

FIG. 1 schematically illustrates an exemplary power generation system, according to some demonstrative embodiment.

FIG. 2 schematically illustrates the tubular apparatus in the power generation system with a first tube end submerged in the water and an opposing second tube end extending outwards from the water with the floatation device extending out of the water, according to some demonstrative embodiment.

FIG. 3 schematically illustrates the tubular apparatus in the power generation system with the second tube end submerged in the water and the opposing first tube end extending outwards from the water with the floatation device extending out of the water, according to some demonstrative embodiment.

FIG. 4 schematically illustrates an exemplary application of the power generation system, according to some demonstrative embodiment.

FIG. 5 schematically illustrates another exemplary application of the power generation system, according to some demonstrative embodiment.

FIG. 6, which schematically illustrates another exemplary application of the power generation system, according to some demonstrative embodiments.

### DETAILED DESCRIPTION

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Some demonstrative embodiments may be related to a power generation system which may utilize two sources of potential energy, a first source associated with the buoyancy of an object and a second source associated with the gravitational pull on the object, to create cyclical motion in a lever system whose motion may be harnessed to generate power. The lever system, which functionally may resemble a seesaw, may include a hollow tubular apparatus which acts as a beam and a base apparatus which acts as a fulcrum and which is submerged underwater anchored to the ground. The tubular apparatus, which may be telescopic, is configured so that, at a predetermined maximum angle relative to a vertical axis of the base apparatus, one end of the tubular apparatus on the downside is lengthened while the opposing end on the upper side is shortened, the lengthening and the shortening of the ends alternating between the ends as the tubular apparatus pivots up and down on the base apparatus.

The tubular apparatus may be a hollow, cylindrically shaped tube, and includes one or more floatation devices configured to be displaced inside the tube as the ends of the tube are alternatively displaced upwards, e.g., first edge of the tubular apparatus, and downwards, e.g., a second edge of the tubular apparatus, during the pivoting action of the tubular apparatus on the base apparatus. The tubular apparatus includes sealing elements which prevent water from flowing into the interior of the hollow tube while submerged in water. The floatation device may be shaped as a rod and may extend outwards from the ends of the hollow tube, while the sealing elements prevent water flow into the tube. Alternatively, the floatation device may have other shapes, for example, a ball which rolls inside the tube as the ends of the tube pivot up and down.

The base apparatus may include a vertical structure, for example, a pole, which may be attached to the tubular apparatus by means of a hinge mechanism to allow pivotal movement of the tubular apparatus. The hinging mechanism may allow pivotal motion to a predetermined angle relative to the vertical axis of the pole, for example, around 70° degrees. The pole may be anchored to the ground underwater. It may be appreciated that the power generation system may be used inside a dedicated water tank or pool so that the base apparatus is anchored to the floor of the pool, although it may also be used in other types of water bodies such as in lakes and in the ocean with proper anchoring means used to secure the base apparatus to the ground.

In operation, when the flotation device is located at the downside end of the tube or optionally proximal thereto or extending outwards therefrom, the buoyancy of the floatation device may cause the downside end to rise while the opposing upside end pivots downwards. In this state, the angle formed by the tube relative to the vertical axis of the pole may be, as previously mentioned, 70° degrees, although it may optionally be more or less. As a result of the angled position of the tube, gravitational forces operating on the self-weight of the floating device may pull the floatation device towards the downside end of the tube (previously the upside end). Once at the downside end, the buoyancy of the floatation device causes the present downside end to rise while the previously downside end is the present pivoted downwards. As previously, once the tube reaches the predetermined angle, the floatation device may be pulled downwards by gravitation back into the previously downside end. This action of both ends pivoting upwards and downward may then be cyclically repeated.

In some embodiments, the power generation system may be connected to a mechanical system that may convert the tubular apparatus's pivotal motion to the rotational motion required to drive an electric generator for generating electricity. Optionally, the power generation system may be connected to a hydraulic system which may drive the electric generator. It may be appreciated that other drive systems, or a combination of drive systems, which may convert the pivotal motion of the tubular apparatus to motion required to drive an electric generator, may be used.

It may be appreciated that the power generation system of the present invention does not incorporate principles of perpetual motion. In perpetual motion, a system always has a starting point, whereas the power generation system may operate from substantially any angle and almost any position. In perpetual motion, a system always requires a source to impart the initial motion, whereas the power generation system, once set in position, is exposed to an energetic environment which drives the system. The system operates on the self-energy it produces and also generates energy outwards, whereas, in the power generation system, two different types of potential energy are synergistically used to create cyclical movement, buoyancy, and gravitation.

It may be further appreciated that there exist some similarities and some differences between the power generation system of the present discloser and renewable energy systems such as wind power systems and solar energy systems. Similarities include that all three systems are non-polluting and that all require a one-time investment. Unlike wind power systems and solar power systems, the power generation system is not susceptible to weather conditions or on time of day.

It may be additionally appreciated that in the power generation system of the present invention, the energies which drive the system do so without a break. The trajectories of the energies end, but as they complement each other, they produce an cyclical motion.

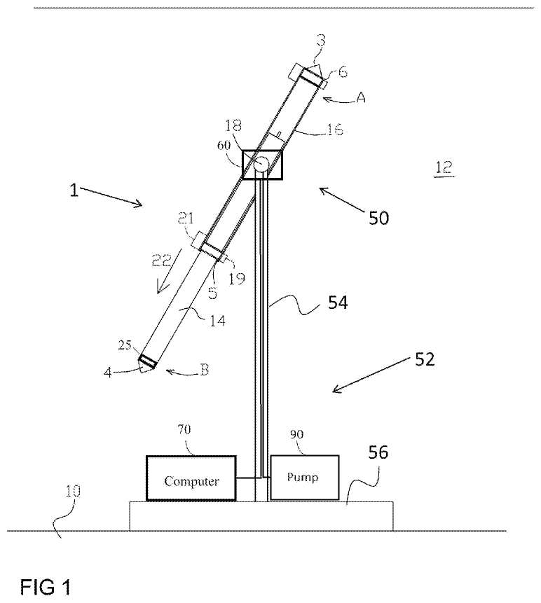

Reference is now made to FIG. 1, which schematically illustrates an exemplary power generation system (1), according to some demonstrative embodiments. The power generation system (1) is shown inside a water tank or pool (10) filled with water (12). The power generation system (1) includes a tubular apparatus (50), a computer (70) to control the movement of the tubular apparatus (50), and a base apparatus (52).

In some demonstrative embodiment, computer (70), e.g., controller, may be placed on a pedestal (56) inside a waterproof case and/or outside the water tank.

The tubular apparatus (50) includes a hollow cylindrical tube (16) which is pivotally attached to a hinge mechanism (18) on the top of a vertical support (54) on the base apparatus (50). The vertical support (54) is mounted on a pedestal (56) which is anchored to the bottom of the tank (10 for securing the power generation system (1) inside the tank. The hinge mechanism (18) may include a computerized locking system (60) which may lock the position of the hollow tube (16) so that the longitudinal axis of the hollow tube (16) is at a predetermined angle relative to the longitudinal axis of the support (54), for example at a 70 degrees angle. For example, the computerized locking system (60) may lock the hinge mechanism (18) so that the position of the hollow tube (16) is at the predetermined angle for a predetermined amount of time required to allow the flotation device to drop from one side of the hollow tube (16) to the other.

The tubular apparatus (50) includes a flotation device (14) configured to be displaced along with the interior of the hollow tube (16) from one side of the tube to the other as the tubular apparatus (50) pivots about the hinging mechanism (18).

In some demonstrative embodiments, the length of flotation device 14 may be longer than the length of the hollow tube (16).

The tube (16) additionally includes at a first tube end a first cap (3) having a magnet (not shown) and/or any other bonding element, and at the opposing second tube end B a second cap (4) having a magnet (25) and/or any other bonding element configured to seal the ends of the tube so that water cannot pass into the ‘tube's interior.

In some demonstrative embodiment may the tube's interior may include a vacuum or very close to vacuum.

In some embodiments, a part of the flotation device (14), e.g., at least half of the length of the flotation device (14), may extend outwardly from the tube (16), as shown in the figure at tube end B. The first cap (3) and/or the second cap (4) at hollow tube (16) ends A and B may be removable and may be attached by the magnet (25) to the flotation device (14) to allow it to protrude outwards. It may be seen in the figure, in an exemplary state of system operation, that the cap (4) is attached to one end of the flotation device (14), which is protruding outwardly from the tube (16) at tube end B, while the cap (3) remains attached to the tube at opposing tube end A. In order to prevent water from flowing into the interior of the tube (16) when flotation device (14) extends outwardly from either tube end A or B, the tube includes a first sealing ring (6) at first tube end (3) and a second sealing ring (5) at second tube end (4). The sealing rings are configured to hermetically surround the perimeter of the outwardly projecting flotation device (14) to prevent water from entering the ‘tube's interior. For example, the first and second sealing rings may include a rod seal groove, O-ring seal, linear power seal, water seal ring, rubber water seal, silicon water seal, and the like.

In some embodiments, to prevent the flotation device (14) from being pushed back into the tube (16) by the buoyancy of the water when the flotation device extends outwardly from the tube, the tubular apparatus (50) includes a stopper mechanism (21) at each tube end A and B. The stopper mechanism (21) may include an electromagnetic device, for example, a solenoid-based device, which, when activated, interacts with a metallic component on the floatation device (14) to prevent the floatation device from moving, essentially locking it in place. The tubular apparatus (50) may additionally include a sensor (19) at the tube ends A and B, which detect when the flotation device (14) is fully extended outwards from tube end A or B to activate the stopper mechanism (21) and lock the flotation device in its extended position.

In some other demonstrative embodiments, system (1) may include a pumping mechanism, e.g., pump (90). Pump (90) may be configured to suck the air from the telescopic tubular apparatus, for example, in order to kept the vacuum inside a hollow cylindrical tube (16).

In some other demonstrative embodiments, system (1) may include a pumping mechanism, e.g., pump (90). Pump (90may be configured to pump a liquid from the telescopic tubular apparatus (16).

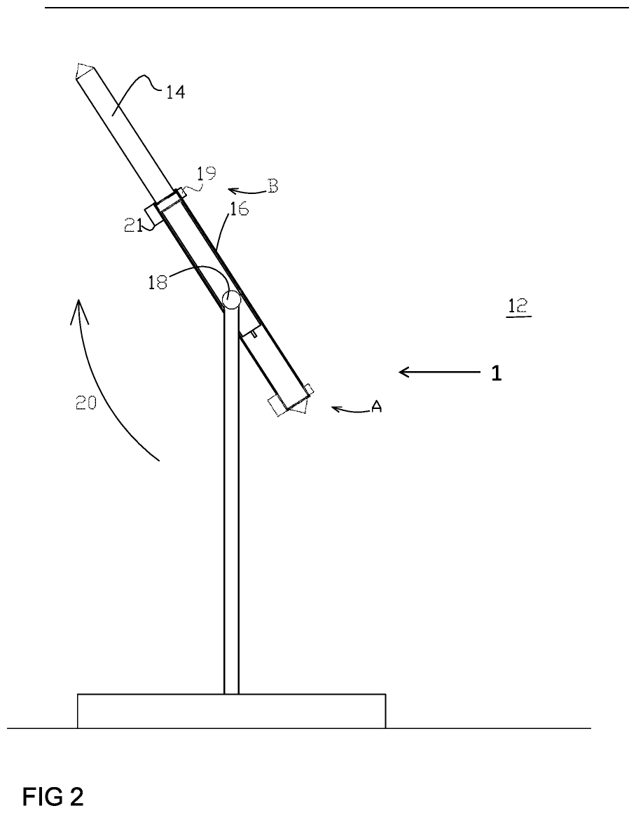

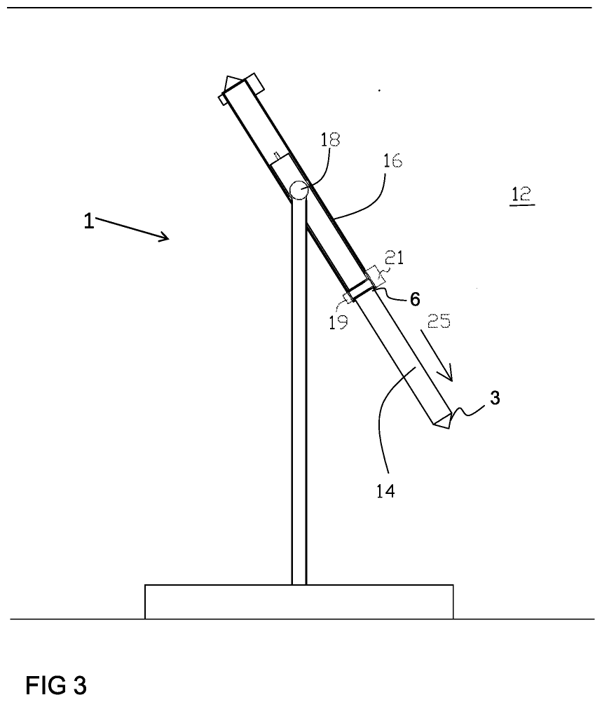

Reference is now also made to FIGS. 2 and 3, which, together with FIG. 1, may serve to describe an exemplary operation of the power generation system (1), according to some demonstrative embodiments.

Shown in FIG. 1 is the tubular apparatus (50) with tube end B downside in the water and tube end A upside in the water. The tube (16) is locked in position at the predetermined maximum angle by the computerized locking system in the hinge mechanism (18) for the amount of time required for the flotation device (14) to drop from tube end A to tube end B and to extend outwards as shown by arrow (22). As the floatation device (14) passes through tube end B, the second cap (4) is attached to the floatation device, the sealing ring (5) preventing water from entering into the interior of the tube (16). Upon the sensor (19) detecting that the floatation device (14) is fully extended outwards, the stopper mechanism (21) is activated to prevent the floatation device from being pushed back into the tube due to the buoyancy.

Shown in FIG. 2 is the tubular apparatus (50) with tube end A downside in the water and tube end B upside in the water with the floatation device (14) extending outwards. Following locking of the floatation device (14) in its fully extended position outwards from tube end B (FIG. 1), the computer locking system in the hinge mechanism (18) releases the tube (16) and allows tube end B to pivot upwards as a result of the floatation device buoyancy, as indicated by arrow 20. Tube end A pivots downwards in the water. When the predetermined maximum locking angle is reached, the computerized locking system locks the hinge mechanism (18) so that tube end B is upside in the water and tube end A is downside in the water. In this position, the sensor (19) deactivates the stopper mechanism (21), releasing the floatation device (14) so that it may drop down the tube (16) toward tube end A.

Shown in FIG. 3 is the tubular apparatus (50) with tube end A downside in the water and tube end B now upside in the water. The tube (16) is locked in position at the predetermined maximum angle by the computerized locking system in the hinge mechanism (18) for the amount of time required for the flotation device (14) to drop from tube end B to tube end A and to extend outwards as shown by arrow (25). As the floatation device (14) passes through tube end A, the first cap (3) is attached to the floatation device by, for example, a magnet (not shown), the sealing ring (6) preventing water from entering into the interior of the tube (16). Upon the sensor (19) detecting that the floatation device (14) is fully extended outwards, the stopper mechanism (21) is activated to prevent the floatation device from being pushed back into the tube due to the buoyancy. Once the floatation device (14) is fully extended, the operation as described in FIG. 2 is repeated except that tube end A now pivots in the direction upwards while tube end B pivots downwards, and the cycle described by FIGS. 1 to 3 may be repeated.

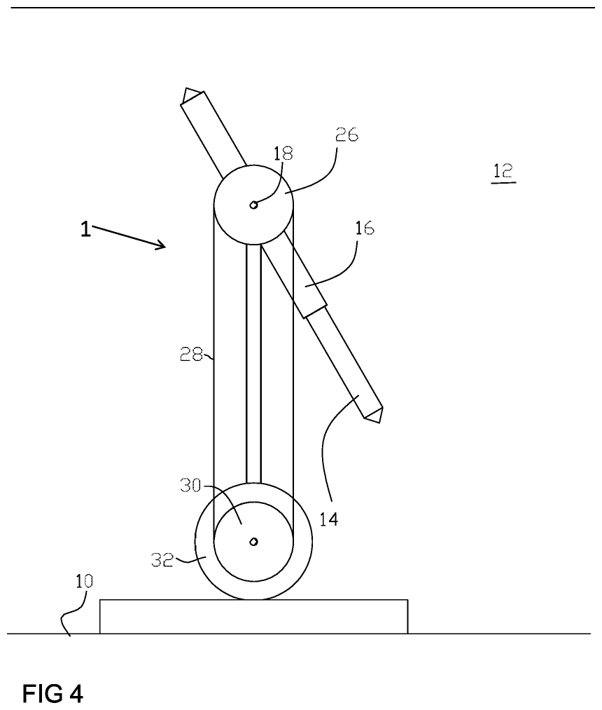

Reference is now made to FIG. 4 which schematically illustrates an exemplary application of the power generation system (1), according to one demonstrating embodiment. In this exemplary application, the power generation system (1) drives a motor (32). A driver pulley wheel (26) is attached to the hinge mechanism (18) and a drive belt (28) is connected at one end to the driver pulley wheel and at the other end to a driven pulley wheel (30). The driven pulley wheel is connected to an electric motor (32) which may be used as a starter.

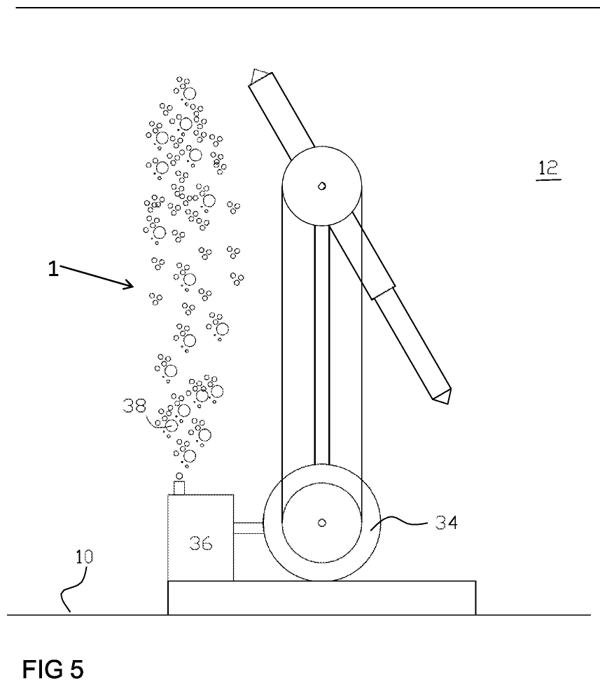

Reference is now made to FIG. 5, which schematically illustrates another exemplary application of the power generation system (1), according to an some demonstrating. In this exemplary application, which is an extension of that shown in FIG. 4, the system includes a generator (34) which may also be operated as a motor, and may include a controller configured to switch between generator operation and motor operation.

In an initial step, the controller may operate the generator (34) as a starter motor to put the power generation system (1) into operation, that is, to cause the cyclical motion of the tubular apparatus (50). In a second step, the controller may switch the motor into a generator (34) which is connected to an ozonator (36) which produces ozone gas (38). The ozonator (36) may release the ozone gas (38) near the bottom of the pool (10) to allow it to mix with the water (12), for example, in a swimming pool, so as not to use chlorine in the pool water. During the operation of the generator (34) a load may be created which may slow down the operation of the power generation system (1), in which case the controller may again switch the generator (34) into an electric motor which will restart the system. A crankshaft and flywheel may be added to the system to maintain the continuous and uniform operation of the system.

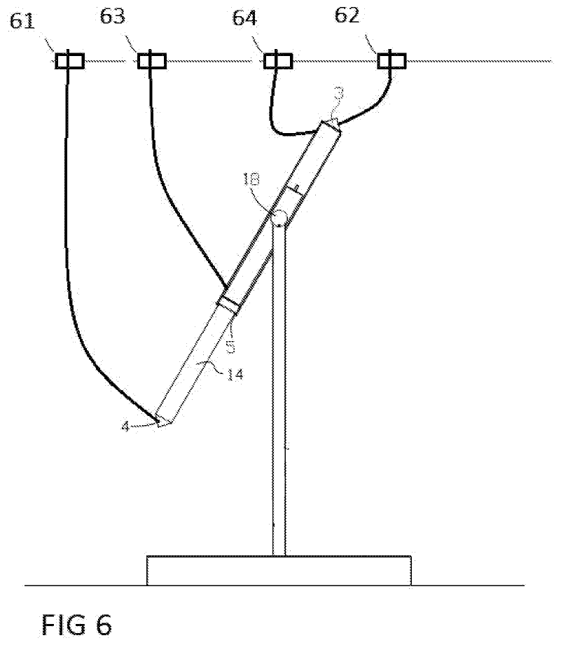

Reference is now made to FIG. 6, which schematically illustrates another exemplary application of the power generation system (1), according to some demonstrative embodiments. In one demonstrative embodiment, system (1) may include a first pipe (61) operably coupled to the first cap (4) and configured to release an air from the telescopic tubular apparatus (16) when the floating device (14) is moving to one direction of the tubular apparatus, e.g., downward, and a second pipe (64) operably coupled to the second cup (3) and configured to release an air from the telescopic tubular apparatus (16) when the floating device (14) may move to opposite direction of the tubular apparatus (16), e.g., upward.

In one other demonstrative embodiment, a first pipe (63) may be operably coupled to a first end of the tubular apparatus (16) and may be configured to release an air from the telescopic tubular apparatus (16) when the floating device (14) may move at one direction of the tubular apparatus (16), e.g., upward, and a second pipe (64) operably coupled to a second end of the tubular apparatus (16) and may be configured to release an air from the telescopic tubular apparatus (16) when the floating device (14) may move to opposite direction of the tubular apparatus (16), e.g., downward.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A power generation system comprising:
a telescopic tubular apparatus comprises:
a hollow cylindrical tube which is pivotally attached to a hinge mechanism on top of a vertical support on a base apparatus; and
a flotation device configured to move inside an interior of the hollow cylindric tube from a first side of the hollow cylindric tube to the second side of the hollow cylindric based on the flotation power of water and a weight of the flotation device and extend outwardly from the tubular apparatus when the tubular apparatus is moving upwards and downwards around the hinge mechanism,
wherein when the hinge mechanism is locked at a predetermined pivot angle, a length of a downward-tilted side of the tubular apparatus is longer than a length of the upwards-tilted side.

2. The system of claim 1 comprises:
a driver pulley wheel operably attached to the hinge mechanism;
a drive belt operably connected at one end to the driver pulley wheel and at the other end to a driven pulley wheel; and
an electric motor connected to the driven pulley wheel, wherein the electric motor is configured to be used as a starter of the telescopic tubular apparatus movement.

3. The system of claim 1, wherein the hollow cylindrical tube comprises a first cap at a first end of the cylindrical tube, wherein the first cap is configured to seal the first end of the cylindrical tube and a second cap at a second end cylindrical tube configured to seal the second end of the cylindrical tube.

4. The system of claim 3, wherein when the floatation device is extended from the first end the first cap is attached to the flotation device by a first magnet and when the floatation device is extended from the second end the first cap is attached to the flotation device by a second magnet.

5. The system of claim 1, wherein the hollow cylindrical tube comprises a first sealing ring at the first end and a second sealing ring at the second end of the cylindrical tube.

6. The system of claim 1 comprises:
a computer configured to:
control a computerized locking system to lock said hinge mechanism at a predetermined angle when the flotation device is downward at a first side of said cylindrical tube;
unlock said hinge mechanism for a predetermined amount of time when the flotation device is upwards at the first side of said hinge mechanism to enable the flotation device to move inside an interior of the hollow cylindrical tube and to pull down a second side of the said cylindrical tube.

7. The system of claim 6, wherein said predetermined angle comprises an angle formed by a longitudinal axis of the tubular apparatus relative to a vertical axis of the base apparatus.

8. The system of claim 6, wherein said predetermined angle is 70° degrees.

9. The system of claim 1 comprises a sensor to detect a position of said flotation device in said tubular apparatus and to lock the flotation device at the detected position, wherein the lock is done by a stopper mechanism.

10. The system of claim 9, wherein the stopper mechanism comprises an electromagnetic device.

11. The system of claim 1, wherein the base apparatus comprises a pedestal configured to secure the power generation system.

12. The system of claim 1, wherein said base apparatus is configured to be submerged in a liquid.

13. The system of claim 1, comprises an ozonator configured to release an ozone gas near the bottom of a pool to be mixed with liquid of the pool.

14. The system of claim 1, wherein comprises a pumping mechanism configure to suck the air from the telescopic tubular apparatus.

15. The system of claim 1, wherein comprises a pumping mechanism configure to pump a liquid from the telescopic tubular apparatus.

16. The system of claim 3 comprises:
a first pipe operably coupled to the first cap and configured to release an air from the telescopic tubular apparatus when the floating device is moving to one direction of the tubular apparatus; and
a second pipe operably coupled to the second cup and configured to release an air from the telescopic tubular apparatus when the floating device is moving to opposite direction of the tubular apparatus.

17. The system of claim 1 comprises:
a first pipe operably coupled to a first end of the tubular apparatus and configured to release an air from the telescopic tubular apparatus when the floating device is moving to one direction of the tubular apparatus; and
a second pipe operably coupled to a second end of the tubular apparatus and configured to release an air from the telescopic tubular apparatus when the floating device is moving to opposite direction of the tubular apparatus.
